(19) United States
(12) Patent Application Publication
(10) Pub. No.: US 2003/0129364 A1
(43) Pub. Date: Jul. 10, 2003

(54) Laminate panel and process for production thereof

(76) Inventor: David D?apos; Arcy Clifford, Caledonia (CA)

Correspondence Address: GOWLING LAFLEUR HENDERSON LLP, COMMERCE COURT WEST, SUITE 4900, TORONTO, ON, M5L 1J3, CA

(21) Appl. No.: 10/285,674

(22) Filed: Nov. 1, 2002

Related U.S. Application Data
(60) Provisional application No. 60/330,848, filed on Nov. 1, 2001.

(51) Int. Cl. B32B 3/00

(52) U.S. Cl. 428/174

(57) ABSTRACT

A laminate panel is described. The panel comprises. A core layer disposed between and bonded to each of a first metal layer and a second metal layer. The core layer comprises a fibrous layer, a first adhesive layer interposed between the first metal layer and a fibrous layer, and a second adhesive layer interposed between the second metal layer and the fibrous layer. Ideally, each of the first adhesive layer and the second adhesive layer impregnate and at least partially saturate the fibrous layer. The first adhesive layer and the second adhesive layer each comprise a thermoplastic resin. The panel is useful inter alia in structural applications (e.g., office building walls and the like) and non-structural applications (e.g., vehicular body panels and the like).

### CROSS REFERENCE TO RELATED APPLICATION

The present application claims the benefit under 35 U.S.C. §119(e) of provisional patent application S. No. 60/330,848, filed Nov. 1, 2001, the contents of which are hereby incorporated by reference.

### BACKGROUND OF THE INVENTION

1. Field of the Invention

In one of its aspects, the present invention relates to a thermoplastic resin impregnated fibrous (e.g., paper) layer product. In another of its aspects, the present invention relates to a laminate panel, more particularly to a metal skinned laminate panel. In yet another of its aspects, the present invention relates to a method for producing a laminate panel.

2. Description of the Prior Art

Sheet steel is used extensively to form panels. The required structural characteristics, such as stiffness, vary depending upon the specific application. When higher stiffness values are required, the steel thickness is typically increased. Increasing sheet steel thickness, however, produces a panel that is not only heavier, but also more expensive.

A number of approaches have been taken in the past to provide improved structural characteristics of panels, without substantially increasing weight or materials cost. For example, composites of steel sheets having a solid polymer core have been used in applications where sound deadening and vibration dampers are required. The specific stiffness of polymer core products, however, is less than desirable

In recent years, attention has been directed to the use of other core materials in metal skinned structural panels.

U.S. Pat. No. 5,985,457 [David D'Arcy Clifford (Clifford #1)] teaches a structural panel which comprises a metal and paper composite in which the metal outer skins have a minimum thickness of 0.005 in. exceeding foils and a maximum thickness of 0.012 in. while the paper core ranges between 0.01 in. and 0.05 in. The panel is a stiff, lightweight substitute for thicker metals and may replace light metal sheets such as aluminum with a composite in which the metal skills comprise sheets from heavier metals such as steel. The paper core is a web which is adhesively bonded to the metal skins and which may have openings to create paths for adhesive bridges between the metal skins to minimize failure caused by buckling.

U.S. Pat. No. 6,171,705 [David D'Arcy Clifford (Clifford #2)] teaches a structural laminate having first and second skins of sheet metal. Each of the sheet metal signs has a thickness of at least about 0.005 inches. A fibrous core layer is provided between the sheet metal skins and is bonded to the skins. In one aspect, the fibrous core layer is impregnated with an adhesive resin which bonds the core layer directly to the skins. In another aspect, layers of adhesive are placed between the core material and the metal skins that bond the core to the skins. While a passing reference is made to the use of a thermoplastic resin as the adhesive, Clifford #2 emphasizes the use of a thermoset resin. The resulting laminate structure is extremely lightweight compared to a single steel sheet of comparable thickness and strength.

While the teachings of Clifford #1 and Clifford #2 represent significant advances in the a there is still room for improvement.

There is a continuing need for laminate panels having improved properties, inter alia, including impact load (or impact resistance). It would be desirable to have such an improved panel. It would also be desirable to have an efficient process for producing such an improved panel.

It is an object of the present invention to obviate or mitigate at least one of the above-mentioned disadvantages of the prior art.

It is another object of the present invention to provide a laminate panel having improved properties (e.g., impact load or impact resistance).

It is another objection of the present invention to provide a novel process for producing a laminate panel

According, in one of its aspects, the present invention provides laminate panel comprising:

a core layer disposed between and bonded to each of a first metal layer and a second metal layer,

the core layer comprising:

a fibrous layer,

a first adhesive layer interposed between the first metal layer and a fibrous layer, and

a second adhesive layer interposed between the second metal layer and the fibrous layer,

wherein the first adhesive layer and the second adhesive layer each comprise a thermoplastic resin.

in another of its aspects, the present invention provides a process for producing a laminate panel comprising the steps of:

disposing a core layer between a first metal layer and a second metal layer to define an interim laminate, the core layer comprising a first adhesive layer and a second adhesive layer on substantially opposed surfaces of a fibrous layer,

subjecting the interim laminate to a first compression step at a first pressure for a first period of time, and subjecting the interim laminate to a second compression step at a second pressure for a second period of time, the second pressure being different than the first pressure, to produce the laminate panel.

In yet another of its aspects, the present invention provides a process for producing a laminate panel comprising the steps of:

disposing a core layer between a first metal layer and a second metal layer to define an interim laminate, the core layer comprising a first adhesive layer and a second adhesive layer on substantially opposed surfaces of a fibrous layer, at least one of the first adhesive layer and the second adhesive layer comprising a thermoplastic resin,

compressing and heating the interim laminate to produce the laminate panel.

In yet another of its aspects, the present invention provides a laminate material comprising a plurality of fibrous layers, each fibrous layer being impregnated with a thermoplastic resin. Preferably, each fibrous layer is a paper layer.

Thus, the present inventor has unexpectedly discovered that the laminate panel described in Clifford #1 and Clifford #2 referred to hereinabove can be significantly improved if use is made of a thermoplastic resin layer between a fibrous layer and an outer metal skin layer. Preferably, the fibrous layer is disposed between a pair of adhesive layers that are, in turn, disposed between a pair of metal skin layers. In a particularly preferred embodiment, the fibrous layer is so-called unsaturated paper—i.e., paper having little or no appreciable resin content. In this particularly preferred embodiment, the thermoplastic resin adhesive layer impregnates and/or at least partially saturates the paper improving the structural properties of the laminate panel.

### BRIEF DESCRIPTION OF THE DRAWINGS

Embodiments of the present invention will be described with reference to the accompanying drawings, wherein like reference numerals denote like parts, and in which:

FIG. 1 illustrates a sectional view an embodiment of the present laminate panel;

FIG. 2 illustrates a perspective view, and partial section of the laminate panel illustrated in FIG. 1; and

FIG. 3 illustrates a sectional view of a second embodiment of the present laminate panel.

### DETAILED DESCRIPTION OF THE PREFERRED EMBODIMENTS

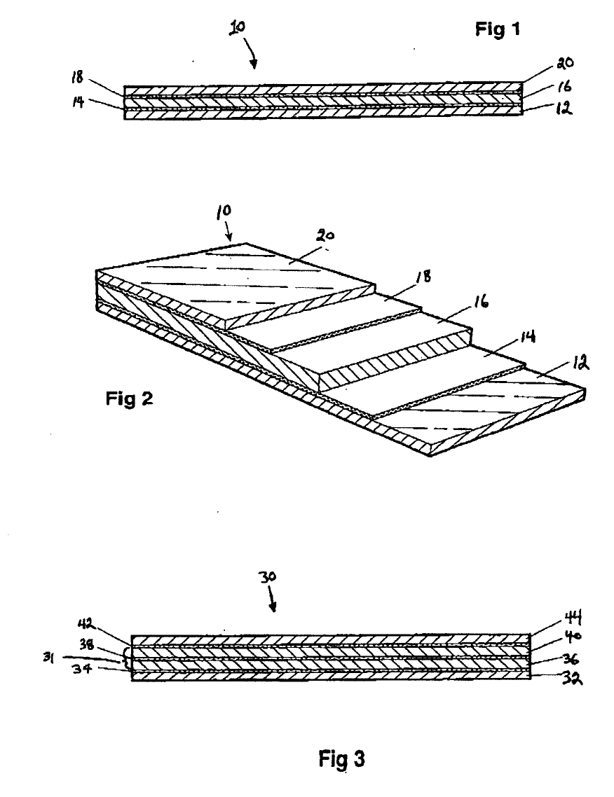

With reference to FIG. 1, there is illustrated a laminate panel 10. Laminate panel 10 includes a first metal shin layer 12 and a second metal skin layer 20. Interposed between first metal skin layer 12 and second metal skin layer 20 is a fibrous layer 16.

A first adhesive layer 14 is disposed between first metal skin layer 12 and fibrous layer 16. A second adhesive layer 18 is disposed between fibrous layer and second metal skin layer 20. At least one, preferably both, of first adhesive layer 14 and second adhesive layer 18 comprises a thermoplastic resin.

First adhesive layer 14 serves to bond first metal skin layer 12 to fibrous layer 16. Second adhesive layer 18 serves to bond fibrous layer 16 to second metal skin layer 20.

With reference to FIG. 3, there is illustrated a laminate panel 30. Laminate panel 30 comprises a first metal skin layer 32 and a second metal skin layer 44. Disposed between first metal skin layer 32 and second metal skin layer 44 is a core 31. Core 31 is bonded to first metal skin layer 32 by a first adhesive layer 34. Further, core 31 is bonded to second metal skin layer 44 by a second adhesive layer 42.

Core layer 31 comprises a pair of fibrous layers 36 and 40 having interposed therebetween an adhesive layer 38.

Those will skill in the art will understand that core 31 may be modified to have more fibrous layers and adhesive layers such that core layer 31 itself is a laminate.

While not shown for purposes of clarity in FIGS. 1-3, it is preferred that one or both, preferably both of the first adhesive layer and the second adhesive layer at least partially impregnate and/or partially (or fully) saturate the adjacent fibrous layer. If a plurality of fibrous layers are used, it is preferred that thermoplastic resin (e.g., from one or both of the first adhesive layer and the second adhesive layer) at least partially impregnates and/or partially (or folly) saturates the adjacent fibrous layer. In this regard, it is preferred that the fibrous layer contains from about 20 to about 50 weight percent, more preferably from about 27 to about 37 weight percent, most preferably from about 30 to about 35 weight percent of thermoplastic resin (present by virtue of pre-impregnation of the fibrous layer, by in situ impregnation during production of the laminate or by a combination of these).

Preferably, both the first adhesive layer and the second adhesive layer comprise a thermoplastic resin. The thermoplastic resin may be the same or different in the first adhesive layer and the second adhesive layer. In one preferred embodiment of the present laminate panel, the thermoplastic adhesive layer comprises polyethylene. A particularly preferred embodiment of polyethylene usefall in the first adhesive layer and/or the second adhesive layer of the present laminate panel is commercially available from Rohm & Haas under the trade name MorMelt™ F823. Alternatively, the thermoplastic resift used in the first adhesive layer and/or the second adhesive layer comprises polypropylene. A non-limiting example of a suitable such thermoplastic material is commercially available from Rohm & Haas under the trade name MorMelt™ F916.

The preferred fibrous core or layer for use in the present laminate panel comprises papers such as Kraft paper. Alternatively, the fibrous core or layer may comprise a plurality of fibrous webs adhesively bonded to one another.

In one embodiment of the present laminate panel, the fibrous layer is a so-called prepreg material. Such a prepreg material is known in the art and is generally regarded as a resin impregnated material. The resin may be a thermoplastic resin as described above or a thermoset resin such as a phenolic resin—see Clifford #1 and Clifford #2 described above for a discussion of useful thermoset resins.

In a particularly preferred embodiment, the fibrous layer is not resin impregnated prior to use so that the only impregnation thereof is from the thermoplastic resin of the adhesive layers of the present laminate panel.

The particular choice for metal skin layers used in the present laminate panel is not particularly restricted and again, more details on this can be see from Clifford #1 and Clifford #2 described above.

Thus, the first metal layer and the second metal layer may be the same or different. Non-limiting examples of suitable metal layers for use in the present laminate include aluminum, cold rolled steel, galvanized steel, tin-coated steel, zinc-coated steel, low carbon micro-alloyed high-strength steel and stainless steel. Preferably, the first metal skin and the second metal skin have the same or different thickness and the thickness is in the range of from about 0.005 inches to about 0.030 inches.

In a preferred embodiment of the present laminate panel one or both of the first metal layer and the second metal layer comprise steel which has been pretreated with a conversion coating to promote bond integrity and corrosion resistance. In a further preferred embodiment of the present laminate panel, the fibrous layer comprises a flame retardant material.

In one embodiment, the present laminate panel may be produced by a process which comprises an initial step of disposing a core layer between a first metal layer and a second metal layer to define an interim lain ate or blank. The core layer comprises a first adhesive layer and a second adhesive layer as described above on substantially opposed surfaces of a fibrous layer as described above. The interim laminate is subjected to a first compression step at a first pressure for a first period of time. Then, the interim laminate is subjected to a second compression step at a second pressure for a second period of time. Preferably, the second pressure is greater than the first pressure.

Preferably, the first compression step and the second compression step are each conducted at a temperature at or above the melting point of thermoplastic resin in the adhesive layer(s). More preferably, the first compression step and the second compression step are each conducted at a temperature in the range of from about 200° F. to about 400° F. Most preferably, the, first compression step and the second compression step is conducted at a temperature in the range of from about 250° F. to about 325° F.

Preferably, the first pressure is less than 150 psi and the second pressure is greater than 150 psi. More preferably, the first pressure is less than about 100 psi and the second pressure is greater than about 175 psi. Even more preferably, the first pressure is less than about 50 psi and the second pressure is greater than about 200 psi. Most preferably, the first pressure is in the range of from from about 15 psi to about 50 psi and the second pressure is in the range of about 200 psi to about 350 psi.

Preferably, the second period of time is greater than the first period of time. Generally, the first period time is that necessary for the thermoplastic resin to melt. It is highly desirable that the thermoplastic resin be substantially completely melted prior to the second compression step. If the thermoplastic resin is not substantially completely melted prior to the second compression step, impregnation of the thermoplastic resin into the fibrous layer(s) is likely to be compromised which will deleteriously affect the performance of the laminate. More preferably, the first period of time is less than 45 seconds and the second period of time is greater than 45 seconds. Even more preferably, the first period of time is less than about 45 seconds and the second period of time is greater than about 60 seconds. Even more preferably, the first period of time is less than about 30 seconds and the second period of time is greater than about 60 seconds. Most preferably, the first period of time is in the range of from about 10 seconds to about 30 seconds and the second period of time is in the range of from about 60 seconds to about 180 seconds.

The above process is ideally suited to produce the present laminate panel when the core layer comprises a thermoset resin prepreg fibrous layer.

When it is desired to produce the present laminate panel using a non-impregnated or unsaturated fibrous layer, it is preferred to apply the thermoplastic resin to either side of the fibrous layer (e.g., by extruding the resin in liquid directly on to the fibrous layer), dispose this laminate between the two metal layers and thereafter compress the resulting laminate at pressures falling within the first compression step described above at the temperatures described above—e.g., temperature of 275° F. at a pressure of 350 psi for a period of 3 minutes to produce a laminate panel having a core thickness of about 0.164 inches (due to the heat transfer phenomenon, the precise period of time may vary and depends, inter alia on core thickness chosen). Optionally, the compression step may be preceded by a preliminary compression step at a pressure falling within the second compression step described above at the temperatures described above. Preferably, the resulting laminate panel comprises impregnation (partial or fall) of the fibrous layer by the adhesive layers on either side thereof resulting in a highly improved laminate panel having a desirable combination of impact resistance, peel strength and moisture resistance.

The foregoing compression steps may be conducted in a die press or other suitable equipment. It is preferred to cool the laminate after the second compression step and before removal of the laminate from the die press or other suitable equipment. This can be achieved in a number of ways. For example, if a die press is used, it is possible to cool the platens used during the compression step prior to removal of the laminate (i.e., while maintaining the second pressure) preferably to a temperature less than the melting point of the resin, more preferably to a temperature in the range of from about 100° F. to the melting point of the resin, even more preferably temperature in the range of from about 100° F. to about 50° F. less than the melting point of the resin, most preferably to a temperature in the range of from about 100° F. to about 100° F. less than the melting point of the resin. Practically, this can be done by switching of the heat applied during the second compression step and running cooling water through each platen. Alternate cooling techniques will be apparent to those of skill in the art.

Those of skill in the art will recognize that the present process can be conducted in a batch press or using continuous laminate equipment.

Another aspect of the present invention relates to a fibrous layer (e.g., a paper layer) impregnated with a thermoplastic resin. The thermoplastic resin may be selected from the preferred embodiments discussed above. Further, the fibrous layer may be produced using the processes described above excluding the metal layers. Once produced, such a fibrous layer may be used as a core layer in the laminate panel above. Alternatively, the fibrous layer may have other applications (e.g., laminate constructions other than those described above and the like). Of course, the fibrous layer may comprise a plurality of individual fibrous layers, each impregnated with the thermoplastic resin, thereby resulting in a laminate structure, with or without further layers (e.g., metal, cover stock and the like).

Embodiments of the present invention will be described with reference to the following Examples which are for illustrative purposes only and should not be used to construe or otherwise limit the scope of the invention.

### EXAMPLE 1

In this Example a metal laminate product was produced in accordance with the teachings of Clifford #2 referred to above. Accordingly, this Example is provide for comparative purposes only and is outside the scope of the present invention.

Initially, a blank was made having a core disposed between two metal skins. The core was a phenolic resin impregnated paper core having 18 plys of paper, each ply having a thickness of 0.010 inches, and the core was cut to a dimension of 18 inches×18 inches. Each metal skin was high strength low alloy sheet steel (60 ksi yield strength) having a thickness of 0.018 inches and was cut to a dimension of 18 inches×18 inches. Such a metal skin is commercially available from Dofasco Inc. under the tradename DOFASCOLOY™ 60F.

The blank was placed in a Carver™ 80 ton hydraulic press equipped with heated platens having a dimension of 18 inches×18 inches. The heated platens were set to a temperature of 380° F. and the blank was compressed between the platens at a pressure of 350 psi for a period of 3 minutes to produce a laminate. The laminate was then removed from the press and allowed to cool to room temperature.

The laminate was then subjected to physical testing. Specifically, the laminate produced in this Example was found to have a T-peel strength of 13 lbs/inch wide. This test was performed by measuring the load required to peel apart a 2 inch width of the laminate over a length of approximately 8 inches

The impact strength of the laminate was then determined according to the following procedure:

Cut sample to a dimension of 4 inches×4 inches.

Place sample flush on a hollow cylindrical cup centrally disposed on base of a drop weight impact tester (cylindrical cup has an outer diameter of 2 inches and an inner diameter of 1½ inches) having supports which do not contact sample.

Raise impact plate on supports (these act as rails for impact plate) the impact plate has a spherical (0.75 inch diameter) impact head weighing 10-25 pounds mounted in the middle thereof—to a prescribed height (31 inches, 35 inches or 39 inches) above the sample.

Release the impact plate allowing gravity to move the impact plate toward the base such that the impact head strikes the sample.

Remove the sample from the drop weight impact tester.

Record any observations (e.g., any cracks formed on the outer or inner portions of the sample).

Upon examination of the laminate sample after impact testing, it was seen that, in cross-section, the core was fractured. This is high disadvantageous since it could lead to failure of the laminate if it used in a structural application where high impact strength is needed (e.g., a vehicular or trailer body panel and the like).

### EXAMPLE 2

In this Example a metal laminate product was produced in accordance with a preferred embodiment of the present invention.

Initially, a blank was made having a core disposed between two metal skins. The core was a thermoplastic resin (Mormelt™ F823 commercially available from Rohm & Haas) impregnated paper core having 18 plys of paper, each ply having a thickness of 0.010 inches, and the core was cut to a dimension of 18 inches×18 inches. The metal skins were the same as those used in Example 1

The blank was placed in a Carver™ 80 ton hydraulic press equipped with heated platens having a dimension of 18 inches×18 inches. The heated platens were set to a temperature of 300° F. and the blank was compressed between the platens at a an initial pressure of 35 psi for a period of 45 seconds (this assured melting of the thermoplastic resin) followed by compression at a pressure of 350 psi for a period of 3 minutes to produce a laminate. While continuing to apply a pressure of 350 psi, the heat to the platens was switched off and cooling water was run through the platens. The laminate was removed after it had cooled to approximately 150° F. and allowed to cool further to room temperate.

The laminate was then subjected to physical testing. Specifically, the laminate produced in this Example was found to have a T-peel strength of 35 lbs/inch wide (average over 6 inches).

The impact strength of the laminate was then determined using the procedure described in Example 1. Upon examination of the laminate sample after impact testing, it was seen that, in cross-section, the core was free of fractures and any other obvious defects. Accordingly, the laminate produced in this Example is more resistant to failure (i.e., compared to the laminate produced in Example 1) if it used in a structural application where high impact strength is needed (e.g., a vehicular or trailer body panel and the like).

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A laminate panel comprising:
a core layer disposed between and bonded to each of a first metal layer and a second metal layer,
the core layer comprising:
a fibrous layer,
a first adhesive layer interposed between the first metal layer and a fibrous layer, and
a second adhesive layer interposed between the second metal layer and the fibrous layer,
wherein the first adhesive layer and the second adhesive layer each comprise a thermoplastic resin.

2. The process defined in claim 1, wherein one or both the first adhesive layer and the second adhesive layer impregnates the fibrous layer.

3. The process defined in claim 1, wherein both the first adhesive layer and the second adhesive layer impregnate the fibrous layer.

4. The process defined in claim 1, wherein the core layer comprises a laminate of alternating fibrous layers and core adhesive layers, the first adhesive layer and the second adhesive layer being disposed on substantially opposed surfaces of the core layer.

5. The process defined in claim 4, wherein the core adhesive layers comprise a thermoplastic resin.

6. The process defined in claim 4, wherein the core adhesive layers comprise a thermoset resin.

7. The laminate panel defined in claim 1, wherein the first adhesive layer and the second adhesive layer each comprise the same thermoplastic resin.

8. The laminate panel defined in claim 1, wherein the first adhesive layer and the second adhesive layer comprise a different thermoplastic resin.

9. The laminate panel defined in claim 1, wherein the thermoplastic resin comprises a polyethylene resin.

10. The laminate panel defined in claim 1, wherein the thermoplastic resin comprises a polyolefin resin.

11. The laminate panel defined in claim 1, wherein the thermoplastic resin comprises a polypropylene resin.

12. The laminate panel defined in claim 1, wherein the first metal layer and the second metal layer are same.

13. The laminate panel defined in claim 1, wherein the first metal layer and the second metal layer are different.

14. The laminate panel defined in claim 1, wherein the first metal layer and the second metal layer are the same or different and each is selected from the group consisting of aluminium, cold rolled steel, galvanized steel, tin-coated steel, zinc-coated steel, low carbon micro-alloyed high-strength steel and stainless steel.

15. The laminate defined in claim 1, wherein the first metal skin and the second metal skin have the same or a different thickness in the range of from about 0.005 inches to about 0.030 inches.

16. The laminate defined in claim 1, wherein the fibrous layer is impregnated with a resin different from the thermoplastic resin

17. The laminate defined in claim 16, wherein the resin comprises a thermoset resin.

18. The laminate defined in claim 1, wherein the fibrous layer has a thickness of at least about 0.01 inches.

19. The laminate defined in claim 1, wherein the fibrous layer has a thickness in the range of from about 0.01 inches and 0.25 inches.

20. The laminate defined in claim 1, wherein the fibrous layer comprises paper.

21. The laminate defined in claim 1, wherein the fibrous layer comprise a plurality of fibrous webs adhesively bonded to each other.

22. The laminate defined in claim 1, wherein the laminate is non-planar.

23. The laminate defined in claim 1, wherein the laminate is planar.

24. The laminate defined in claim 1, wherein one or both of the first metal skin and the second metal skin comprise steel which has been pretreated with a conversion coating to promote bond integrity and corrosion resistance.

25. The laminate defined in claim 1, wherein the fibrous layer comprises a flame retardant material.

26. A process for producing a laminate panel comprising the steps of:
disposing a core layer between a first metal layer and a second metal layer to define an interim laminate, the core layer comprising a first adhesive layer and a second adhesive layer on substantially opposed surfaces of a fibrous layer,
subjecting the interim laminate to a first compression step at a first pressure for a first period of time, and
subjecting the interim laminate to a second compression step at a second pressure for a second period of time, the second pressure being different than the first pressure, to produce the laminate panel.

27. The process defined in claim 26, wherein the first pressure is less than 150 psi and the second pressure is greater than 150 psi.

28. The process defined in claim 26, wherein the first pressure is less than about 100 psi and the second pressure is greater than about 175 psi.

29. The process defined in claim 26, wherein the first pressure is less than about 50 psi and the second pressure is greater than about 200 psi.

30. The process defined in claim 26, wherein the first pressure is in the range of from about 15 to about 50 psi and the second pressure is in the range of from about 200 psi to about 350 psi.

31. The process defined in claim 26, wherein the second period of time is greater than the first period of time.

32. The process defined in claim 26, wherein first period of time is less than 45 seconds and second period of time is greater than 45 seconds.

33. The process defined in claim 26, wherein first period of time is less than about 45 seconds and second period of time is greater than 60 seconds.

34. The process defined in claim 26, wherein first period of time is less than about 30 seconds and second period of time is greater than 60 seconds.

35. The process defined in claim 26, wherein first period of time is in the range of from about 10 to about 30 seconds and second period of time is in the range of from about 60 to about 190 seconds.

36. The process defined in claim 26, wherein one or both of the first compression step and the second compression step is conducted at a temperature at or above the melting point of the thermoplastic resin.

37. The process defined in claim 26, wherein one or both of the first compression step and the second compression step is conducted at a temperature in the range of from about 200° F. to about 400° F.

38. The process defined in claim 26, wherein one or both of the first compression step and the second compression step is conducted at a temperature in the range of from about 250° F. to about 325° F.

39. The process defined in claim 26, wherein the first adhesive layer and the second adhesive layer each comprise a thermoplastic resin.

40. The process defined in claim 26, wherein one or both the first adhesive layer and the second adhesive layer impregnate the fibrous layer.

41. The process defined in claim 26, wherein both the first adhesive layer and the second adhesive layer impregnate the fibrous layer.

42. The process defined in claim 26, wherein the core layer comprises a laminate of alternating fibrous layers and core adhesive layers, the first adhesive layer and the second adhesive layer being disposed on substantially opposed surfaces of the core layer.

43. The process defined in claim 42, wherein the core adhesive layers comprise a thermoplastic resin.

44. The process defined in claim 42, wherein the core adhesive layers comprise a thermoset resin.

45. The process defined in claim 26, wherein the first adhesive layer and the second adhesive layer each comprise the same thermoplastic resin.

46. The process defined in claim 26, wherein the first adhesive layer and the second adhesive layer comprise a different thermoplastic resin.

47. The process defined in claim 26, wherein the thermoplastic resin comprises a polyethylene resin.

48. The process defined in claim 26, wherein the thermoplastic resin comprises a polyolefin resin.

49. The process defined in claim 26, wherein the thermoplastic resin comprises a polypropylene resin.

50. The process defined in claim 26, wherein the first metal layer and the second metal layer are same.

51. The process defined in claim 26, wherein the first metal layer and the second metal layer are different.

52. The process defined in claim 26, wherein the first metal layer and the second metal layer are the same or different and each is selected from the group consisting of aluminium, cold rolled steel, galvanized steel, tin-coated steel, zinc-coated steel, low carbon micro-alloyed high-strength steel and stainless steel.

53. The process defined in claim 26, wherein the first metal skin and the second metal skin have the same or a different thickness in the range of from about 0.005 inches to about 0.030 inches.

54. The process defined in claim 26, wherein the fibrous layer is impregnated with a resin different from the thermoplastic resin

55. The process defined in claim 54, wherein the resin comprises a thermoset resin.

56. The process defined in claim 26, wherein the fibrous layer has a thickness of at least about 0.01 inches.

57. The process defined in claim 26, wherein the fibrous layer has a thickness in the range of from about 0.01 inches and 0.25 inches.

58. The process defined in claim 26, wherein the fibrous layer comprises paper.

59. The process defined in claim 26, wherein the fibrous layer comprise a plurality of fibrous webs adhesively bonded to each other.

60. The process defined in claim 26, wherein the laminate is non-planar.

61. The process defined in claim 26, wherein the laminate is planar.

62. The process defined in claim 26, wherein one or both of the first metal skin and the second metal skin comprise steel which has been pretreated with a conversion coating to promote bond integrity and corrosion resistance.

63. The process defined in claim 26, wherein the fibrous layer comprises a flame retardant material.

64. A process for producing a laminate panel comprising the steps of:
disposing a core layer between a first metal layer and a second metal layer to define an interim laminate, the core layer comprising a first adhesive layer and a second adhesive layer on substantially opposed surfaces of a fibrous layer, at least one of the first adhesive layer and the second adhesive layer comprising a thermoplastic resin,
compressing and heating the interim laminate to produce the laminate panel.

65. The process defined in claim 64, wherein the heating step is conducted at a temperature in the range of from about 200° F. to about 400° F.

66. The process defined in claim 64, wherein the beating step is conducted at a temperature in the range of from about 250° F. to about 325° F.

67. The process defined in claim 63, wherein the first adhesive layer and the second adhesive layer each comprise a thermoplastic resin.

68. The process defined in claim 63, wherein one or both the first adhesive layer and the second adhesive layer impregnate the fibrous layer.

69. The process defined in claim 63, wherein both the first adhesive layer and the second adhesive layer impregnate the fibrous layer.

70. The process defined in claim 63, wherein the core layer comprises a laminate of alternating fibrous layers and core adhesive layers, the first adhesive layer and the second adhesive layer being disposed on substantially opposed surfaces of the core layer.

71. The process defined in claim 70, wherein the core adhesive layers comprise a thermoplastic resin.

72. The process defined in claim 70, wherein the core adhesive layers comprise a thermoset resin.

73. The process defined in claim 63, wherein the first adhesive layer and the second adhesive layer each comprise the same thermoplastic resin.

74. The process defined in claim 63, wherein the first adhesive layer and the second adhesive layer comprise a different thermoplastic resin.

75. The process defined in claim 63, wherein the thermoplastic resin comprises a polyethylene resin.

76. The process defined in claim 63, wherein the thermoplastic resin comprises a polyolefin resin.

77. The process defined in claim 63, wherein the thermoplastic resin comprises a polypropylene resin.

78. The process defined in claim 63, wherein the first metal layer and the second metal layer are same.

79. The process defined in claim 63, wherein the first metal layer and the second metal layer are different.

80. The process defined in claim 63, wherein the first metal layer and the second metal layer are the same or different and each is selected from the group consisting of aluminium, cold rolled steel, galvanized steel, tin-coated steel, zinc-coated steel, low carbon micro-alloyed high-strength steel and stainless steel.

81. The process defined in claim 63, wherein the first metal skin and the second metal skin have the same or a different thickness in the range of from about 0.005 inches to about 0.030 inches.

82. The process defined in claim 63, wherein the fibrous layer is impregnated with a resin different from the thermoplastic resin

83. The process defined in claim 82, wherein the resin comprises a thermoset resin.

84. The process defined in claim 63, wherein the fibrous layer has a thickness of at least about 0.01 inches.

85. The process defined in claim 63, wherein the fibrous layer has a thickness it) the range of from about 0.01 inches and 0.25 inches.

86. The process defined in claim 63, wherein the fibrous layer comprises paper.

87. The process defined in claim 63, wherein the fibrous layer comprises a plurality of fibrous webs adhesively bonded to each other.

88. The process defined in claim 63, wherein the laminate is non-planar.

89. The process defined in claim 63, wherein the laminate is planar.

90. The process defined in claim 63, wherein one or both of the first metal skin and the second metal skin comprise steel which has been pretreated with a conversion coating to promote bond integrity and corrosion resistance.

91. The process defined in claim 63, wherein the fibrous layer comprises a flame retardant material.

92. A laminate material comprising a plurality of fibrous layers, each fibrous layer being impregnated with a thermoplastic resin.

93. The composite material defined in claim 92, wherein the fibrous layers comprise paper.

94. The composite material defined in claim 92, wherein the thermoplastic resin is selected from the group comprising polyethylene, polypropylene and mixtures thereof.
